(19) United States
(12) Patent Application Publication
(10) Pub. No.: US 2024/0337791 A1
(43) Pub. Date: Oct. 10, 2024

(54) Photonic Integrated Rapidly Switchable High Contrast Filter

(71) Applicant: The Regents of the University of California, Oakland, CA (US)

(72) Inventors: Daniel J. Blumenthal, Santa Barbara, CA (US); Jiawei Wang, Goleta, CA (US); Nitesh Chauhan, Goleta, CA (US)

(73) Assignee: The Regents of the University of California, Oakland, CA (US)

(21) Appl. No.: 18/542,497

(22) Filed: Dec. 15, 2023

Related U.S. Application Data
(60) Provisional application No. 63/387,611, filed on Dec. 15, 2022.

(51) Int. Cl. G02B 6/293

(52) U.S. Cl. CPC G02B 6/29343

(57) ABSTRACT

Systems and methods for fast switchable optical filters with high extinction ratio are described. The fast switchable and high extinction ratio optical filters can be based on coupled ultra-high quality factor resonators that are actuated using stress-optical actuators.

### CROSS-REFERENCE TO RELATED APPLICATIONS

The current application claims the benefit of U.S. Provisional Patent Application No. 63/387,611 entitled “Photonic Integrated Rapidly Switchable High Contrast Filter” filed Dec. 15, 2022. The disclosure of U.S. Provisional Patent Application No. 63/387,611 is hereby incorporated by reference in its entirety for all purposes.

### STATEMENT OF FEDERALLY SPONSORED RESEARCH

This invention was made with government support under W911NF-22-2-0056 awarded by the Army Research Laboratory—Army Research Office. The government has certain rights in the invention.

### FIELD OF THE INVENTION

The present invention generally relates to methods and systems for fast switchable optical filters with high extinction ratio.

### BACKGROUND OF THE INVENTION

Optical filters are used to selectively transmit or reject a wavelength or range of wavelengths. The extinction ratio of an optical switch is the ratio of the optical power transmitted in the ON state to the power transmitted in the OFF state. It's expressed in decibels (dB). Optical filters can be used for multiple functions, including to filter out unwanted signals or noise, to maximize signal to noise ratio, to select a desired signal from a communications channel, or to pass or block an optical signal. The optical signal input to the filter can be continuous wave light generated by a laser, pulsed light generated by a laser, a laser with information modulated onto it directly, or a comb of multiple frequencies generated by an optical frequency comb. The filter can also be tuned with a time varying signal, forming a modulator function, and also a blanking gate where the output turns from on with very low loss to off with very high extinction.

### BRIEF SUMMARY OF THE INVENTION

Methods and systems for fast switchable optical filters are described.

Some embodiments of the invention include a high contrast optical filter comprising: a first ring resonator coupled with a first waveguide; and a second ring resonator coupled with a second waveguide, wherein the first waveguide directs a light in and the second waveguide directs the light out; wherein each of the ring resonator is integrated with an actuator; and wherein the optical filter switches at a bandwidth greater than 1 kHz with a switch time less than 100 ns.

Some embodiments further comprise at least one more ring resonator, wherein the at least one more ring resonator is coupled in between the first and the second ring resonators, wherein each of the at least one more ring resonator is coupled with an actuator.

In some embodiments, the first ring resonator, the second ring resonator, and the at least one more ring resonator are arranged in a pattern selected from the group consisting of: a coupled linear array, a coupled parallel array, and a 2D array.

In some embodiments, the actuator is a stress-optical actuator, an electro-optical actuator, or a thermo-optical actuator.

Some embodiments further comprise a heater, wherein the actuator is a thermo-optic actuator.

In some embodiments, the heater comprises a thermally conductive metal.

In some embodiments, the optical filter is configured to be a portion of a blanking gate.

In some embodiments, the actuator is a ring actuator or a phase actuator.

In some embodiments, the first and the second ring resonators have a circular shape.

In some embodiments, each of the actuator is laterally and vertically offset from a core of each of the ring resonator and from an optical mode profile of the ring resonator such that the actuator does not appreciably affect a waveguide loss or a resonator quality factor (Q).

In some embodiments, the core of each of the ring resonator comprises a material selected from the group consisting of: silicon nitride, tantalum pentoxide, alumina oxide, and aluminum nitride.

In some embodiments, the actuator comprises lead zirconate titanate (PZT) and the ring resonator comprises silicon nitride, and the filter functions at a wavelength selected from the group consisting of: a visible wavelength range from 400 nm to 750 nm, a near IR wavelength range from 700 nm to 2500 nm, and a mid IR wavelength range from 2500 nm to 25,000 nm.

In some embodiments, the actuator comprises PZT and the ring resonator comprises tantalum pentoxide, alumina oxide, or aluminum nitride, and the filter functions at a wavelength range selected from the group consisting of: a far-UV wavelength range from 100 nm to 200 nm, a mid-UV wavelength range from 200 nm to 300 nm, a near UV wavelength range from 300 nm to 400 nm, and a visible, near IR and mid-IR wavelength range from 400 nm to 2350 nm.

In some embodiments, each of the ring resonator is a high quality factor (Q) resonator.

In some embodiments, the high Q resonator has a Q of at least 40 million.

In some embodiments, the optical filter is compatible with CMOS foundry fabrication process.

In some embodiments, the optical filter comprises three ring resonators and three metal heaters; wherein the optical filter operates at 1550 nm wavelength, wherein the optical filter has an extinction ratio of greater than or equal to 100 dB at 6GHz bandwidth.

In some embodiments, the optical filter comprises three ring resonators and three metal heaters; wherein the optical filter operates 493 nm wavelength; wherein the optical filter has an extinction ratio of greater than or equal to 80 dB at 1 GHz bandwidth.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1A illustrates a schematic of a high contrast filter in accordance with an embodiment.

FIG. 1B illustrates a cross section of the high contrast filter in accordance with an embodiment.

FIG. 2A illustrates the Q measurement of a high contrast filter in accordance with an embodiment.

FIG. 2B illustrates the frequency response (S11) of a high contrast filter in accordance with an embodiment of the invention.

FIGS. 2C and 2D illustrate coupling rate of a high contrast filter in accordance with an embodiment.

FIG. 3A illustrates a schematic of a high contrast filter with serially coupled 3 ring resonators in accordance with an embodiment.

FIGS. 3B and 3C illustrate the performance of the 3^{rd} order filter in accordance with an embodiment.

FIG. 4A illustrates a schematic of a high contrast filter with serially coupled 4 ring resonators in accordance with an embodiment.

FIGS. 4B and 4C illustrate the performance of the 4^{th} order filter in accordance with an embodiment of the invention.

FIGS. 5A through 5C illustrate high-order ring filter simulation in accordance with an embodiment.

FIGS. 6A through 6C illustrate a high contrast filter for visible wavelength in accordance with an embodiment.

### DETAILED DESCRIPTION

Methods to pass through or block or filter optical signals with extremely high contrast ratio between the on and off states may be needed for precision applications such as quantum computing and sensing, atomic clocks and navigation, precision metrology, and communications systems such as microwave and RF and fiber optic. Optical filtering applications can benefit from the invention where maximizing signal to noise ratio, extracting signals from a communications channel with high rejection of unwanted channels and noise, and rapid reconfiguration are desirable. These functions can be referred to as blanking gates, or fast tunable high extinction ratio filters, where the attenuation of the input optical signal is greater than about 80 dB or about 90 dB; or from about 90 dB to about 100 dB; or greater than about 100 dB; or from about 100 dB to about 120 dB; or greater than about 120 dB. The high contrast ratio ensures that little optical energy passes through in the blanking state, for example no photons for a photon-based quantum gate. The high contrast ratio enables high channel rejection for a multi-channel communications or other multi-channel system, or maximization of signal to noise ratio for narrow band or other modulated optical signals. In order to be useful for quantum and atomic systems and other applications, the switching time between on-off or off-on should be faster than about 1 millisecond, preferably faster than about 1 microsecond. The blanking, or on-off function can also be optical wavelength selective, so as to affect only one color of light and not affect other colors, or the gate can provide high contract on-off gating to multiple colors at the same time, or the gate can act on all colors at the same time, or the gate can select one or more optical channels from a multi-channel system. The fast switchable filter, or blanking gate, should have a design that can operate at wavelengths in the ultra-violet (UV), the visible (VIS), the near infrared (NIR), and the mid infrared (MIR).

Current options for fast switchable and high extinction ratio gates and switches and filters are limited as the gates or filters or switches used to realize them have limited extinction ratio and tuning or switching time (speed). They are usually constructed using bulk-optic, bulky, table top, high power components that cannot be integrated with other components onto small, low cost, low power integrated chips. High extinction ratio gates, filters or switches on compact and low-cost integrated chips can be important to commercial applications from atomic, to quantum, to communications, and to metrology. High performance and integrated photonic chips can enable larger numbers of stabilized lasers to be used in applications that require large numbers of lasers such as quantum computing and realizing small, lightweight versions for applications such as space-based applications.

Many embodiments provide fast switchable optical filters with high extinction ratio (ER). The fast switchable and high extinction ratio (or high contrast) optical filters in accordance with several embodiments can be based on coupled ultra-high Q resonators that are actuated using stress-optical actuators including (but not limited to) piezo-electric actuators. In various embodiments, stress-optic actuators couple with the resonators. The actuators can be piezo-electric actuators. The actuators can be ring actuators or phase actuators. The actuators can comprise piezo-electric materials such as (but not limited to) lead zirconate titanate (PZT) or aluminum nitride. The ring resonators have a core that can be made of materials such as silicon nitride, tantalum pentoxide, alumina oxide or aluminum nitride. Materials such as tantalum pentoxide, alumina oxide or aluminum nitride can achieve a wide band gap modulation where the modulators function at a far-UV range from about 100 nm to about 200 nm, a mid-UV range from about 200 nm to about 300 nm, a near UV range from about 300 nm to about 400 nm, and visible, near IR and mid-IR ranges from about 400 nm to about 2350 nm, and beyond. Modulated filters and gates with silicon nitride resonators can achieve modulation and filtering and blanking at a wavelength of a visible wavelength range from about 400 nm to about 750 nm, a near IR wavelength range from about 700 nm to about 2500 nm, and a mid IR wavelength from about 2500 nm to about 25,000 nm. As can be readily appreciated, any of a variety of a stress-optical actuator can be utilized in the high contrast filters appropriate to the requirements of specific applications in accordance with various embodiments of the invention.

In certain embodiments, the stress-optic actuators can be circular piezo-electric actuators. The piezo-electric actuators can be offset from the ring resonators such that a first circular portion of the circular piezo-electric actuator is located on the outside of the ring resonators and a second circular portion of the circular piezo-electric actuator is located on the inside of the ring resonator. The circular piezo-electric actuators can be separated from the ring resonators by a top cladding layer. The circular piezo-electric actuators can change the guiding properties of the ring resonators based on the voltage applied to the circular piezo-electric actuators by inducing strain through the top cladding layer to change the optical properties of the ring resonators.

The fabrication processes of the optical filters, the actuators, and the ring-resonator are compatible with CMOS foundry processes. The PZT stress-optic actuator has a DC to 25 MHz 3-dB optical modulation bandwidth, a low optical loss of about 0.03 dB/cm at 1550 nm (or a loss of about 0.3 dB/cm at 780 nm; or a loss of about 0.6 dB/cm at 674 nm; or a loss of about 9 dB/cm at about 461 nm), and ultra-low power consumption of about 20 nW. (See, e.g., U.S. patent application Ser. No. 18/485,173 filed Oct. 11, 2023; the disclosure of which is hereby incorporated by reference.)

In some embodiments, the high contrast filters can include at least two coupled resonators; or three coupled resonators; or at least three coupled resonators; or four coupled resonators; or at least four coupled resonators. The resonators can be arranged in a coupled linear array, or in coupled parallel arrays, or in a 2D array, or in other arrangements that couple input and output waveguides to the at least one coupled resonator and couple the other resonators to each other. The resonators can be realized using bus-coupled ring waveguide structures, or other resonator structures that have waveguide input and output coupling. Preferably, the waveguide technology is very low loss at the operating wavelengths, for example less than about 10 dB/meter, or less than about 5 dB/meter, or less than about 2 dB/meter, or less than 1 dB/meter. As can be readily appreciated, any of a number of coupled resonators can be utilized in the high contrast filters appropriate to the requirements of specific applications in accordance with various embodiments of the invention.

The stress optical modulation preserves the ultra-high Q of the resonators and the extinction ratio of the optical filter. In many embodiments, the stress-optic actuators are capable of switching from about 1 kHz to about 10 KHz, or from about 10 KHz to about 100 kHz, or from about 100 kHz to about 1 MHz, or from about 1 MHz to about 10 MHZ, or from about 10 MHz to about 100 MHz, or from about 100 MHz to about 1 GHZ, or over about 1 GHz speeds including (but not limited to) in about 100 ns to about 10 ns, or in about 10 ns to about 1 ns. In a number of embodiments, all the rings in a filter can be switched at the same time such that the filter itself can be switched into or out of the signal. In some embodiments, the filters may be aligned spectrally. In certain embodiments, the filters can be misaligned intentionally. The filters can also be apodized in order to create a flat-top filter shape. In order to make a fast gate, the rings can be designed and organized in a manner that the switching time of the filter is not limited by the photon lifetime of the filter, but instead by the PZT or electrical contact switching time in accordance with several embodiments. Many embodiments implement PZT actuators in the high contrast filters to provide the benefits of high optical Q which translates to high extinction ratio and fast switching time. The fast switchable and high contrast filters in accordance with many embodiments can be implemented in the silicon nitride photonic integration systems that are compatible with CMOS foundry processes.

In various embodiments, tuning mechanisms such as thermo-optic, and electro-optic as well as other tuning mechanisms can be used instead of or combined, or in addition to stress-optic tuning to realize the switchable and tunable optical filter or blanking gate. In several embodiments, thermo-optic tuning utilizes (but not limited to) metal heater tuners with PZT actuators. In some embodiments, electro-optic tuning implements materials such as (but not limited to) lithium niobite (LiN) that utilizes electro-optic effect to modulate waveguides (such as silicon nitride waveguides, silicon nitride resonators) without the bulky optical components.

Many embodiments integrate low loss modulators on CMOS wafer-scale manufacturable photonic platforms in the high contrast and fast switchable filters. Examples of photonic platforms and/or waveguide platforms include (but are not limited to) silicon nitride, tantalum pentoxide, amorphous alumina oxide, and aluminum nitride. As can be readily appreciated, any of a variety of a photonic platform can be utilized appropriate to the requirements of specific applications in accordance with various embodiments of the invention. The ultra-low loss modulators in accordance with several embodiments reduce cost, size and complexity of conventional bulk-optic modulation. In various embodiments, the PZT actuators can be used to fast switch the high contrast filters into and out of the signal carrier frequency. The fast switch and high contrast filters in accordance with many embodiments can achieve a switch time of less than about 10 ns. The fast switch time enable by the PZT actuators may not be realized by conventional low-speed thermal tuner.

In many embodiments, at least two high-order ring resonators can be serially coupled for the fast switchable and high contrast filters. Examples of ring resonators include (but not limited to) silicon nitride ring resonators. As can be readily appreciated, any of a variety of a ring resonator can be utilized appropriate to the requirements of specific applications in accordance with various embodiments of the invention. In several embodiments, the high contrast filter can achieve high extinction ratio with flat wide bandwidth. The filter in accordance with some embodiments can be designed across various optical wavelengths from infrared wavelength to visible light wavelength, depending on the applications. Several embodiments can change various parameters of the high contrast filter including (but not limited to) the radius of the ring resonator or the thickness of the silicon nitride layer, to design a desired wavelength for the filter. In certain embodiments, the high contrast filter can be a 1550 nm filter, with a ring resonator radius of about 580 μm and silicon nitride thickness of about 175 nm. In some embodiments, the 1550 nm filter can achieve about 6 GHz bandwidth and over about 100 dB extinction ratio. In a number of embodiments, the high contrast filter can be a 493 nm filter, with a ring radius of about 800 μm and silicon nitride thickness of about 20 nm. In several embodiments, the 493 nm filter can achieve about 1 GHz bandwidth and over about 80 dB extinction ratio. The waveguide core material thickness, waveguide width, radius of curvature, ring diameter and other aspects are design choices that can be varied according to desired wavelengths of operation, desired losses, desired filter characteristics, desired waveguide materials, and other aspects that are related to design choices.

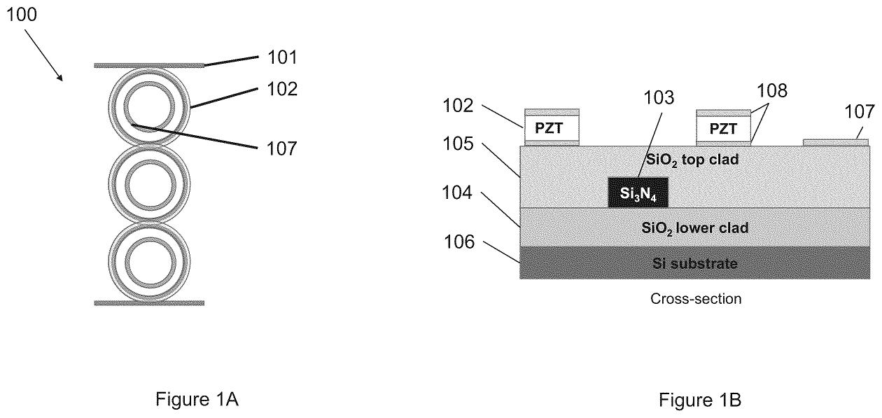

FIG. 1A illustrates a schematic of a high contrast filter in accordance with an embodiment of the invention. FIG. 1B illustrates a cross section of the high contrast filter in accordance with an embodiment. The high-contrast filter 100 can be made of serially coupled high-order silicon nitride ring resonators, where high extinction ratio with flat wide bandwidth could be achieved by this configuration. FIG. 1A shows a filter with serially coupled 3 ring resonators 101. Although not shown in FIG. 1A, more than 3 ring resonators; or 4 ring resonators; or more than 4 ring resonators; can be used for the filter. Higher number of ring resonators may result in higher extinction ratio, but may consume more power. The PZT actuators 102 can form concentric rings. The PZT actuators are below electrodes 108. These electrodes may be utilized as heaters 107.

As can be seen in FIGS. 1A and 1B, the high-contrast filter 100 includes a silicon nitride ring resonator 101 and a PZT actuator 102. The silicon nitride ring resonator can be monolithically integrated with PZT actuator. As can be readily appreciated, the resonator can have any of a variety of a circular shape as appropriate to the requirements of specific applications in accordance with various embodiments of the invention. The ring resonator can include a Si₃N₄ waveguide core 103. The SiₛN₄ waveguide core can be sandwiched between a lower silicon oxide cladding layer 104 and a top silicon oxide cladding layer 105. The lower silicon oxide cladding layer 104 can be thermally grown on a silicon substrate 106. In some embodiments, chemical mechanical polishing can be performed on top of the upper silicon oxide layer 105 to planarize the surface. A PZT layer 102 can be deposited on the waveguide core 103. As can be readily appreciated, a variety of materials can be used for the cladding layers as appropriate to the requirements of specific applications in accordance with various embodiments of the invention.

The PZT layer 102 can have upper and lower platinum (Pt) electrodes 108 to establish electrical contact. An adhesion layer (not shown) including (but not limited to) TiO₂ adhesion layer can be deposited between the electrode 108 and the top silicon oxide cladding layer 105. In several embodiments, the PZT layer 102 can be deposited and patterned laterally and/or vertically offset from the waveguide core 103 by a distance with respect to its center. The PZT actuator dimensions and waveguide-offset are designed to achieve a large lateral strain effect across the nitride core while minimizing overlap with the optical mode, and therefore minimize optical losses. In certain embodiments, the optical modes of the actuator and the resonator are not overlapped. The off-set distance is the distance from the inner edge of the PZT layer 102 to the center of the waveguide core 103. The off-set distance between the PZT layer and the center of the SiₛN₄ core can be from about 2 μm to about 5 μm; or less than about 2 μm; or greater than about 5 μm; or no off-set. The off-set distance may depend on the device design and the wavelength. While these waveguide-offset piezo-electric actuators have been described in the context of ring modulators, it is understood that this design may be applicable to semiconductor waveguides in general such as a straight waveguide or waveguides of arbitrary routing patterns, for example serpentines. The piezo-electric actuators may change the phase of light propagating through the waveguide based on the voltage applied to the piezo-electric actuators.

The PZT actuators enable fast switch time of less than about 10 ns of the high contrast filter. In many embodiments, PZT offsets can be designed at different wavelength so that the low waveguide losses are not perturbed, and enable high Q resonators, so that high extinction ratio filter can be achieved. In several embodiments, the bottom electrode layer 108 (such as Pt electrode) of the PZT actuator 102 can be used as the heater 107, if the ring resonators' resonance need to be aligned. The fabrication process of the filter is compatible with the CMOS foundry processes. Other fabrication processes, preferably compatible with the CMOS foundry processes, can be used to realize this technology.

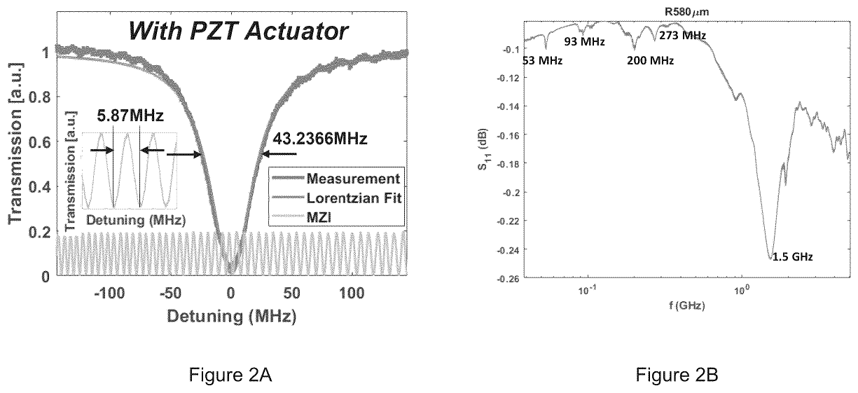

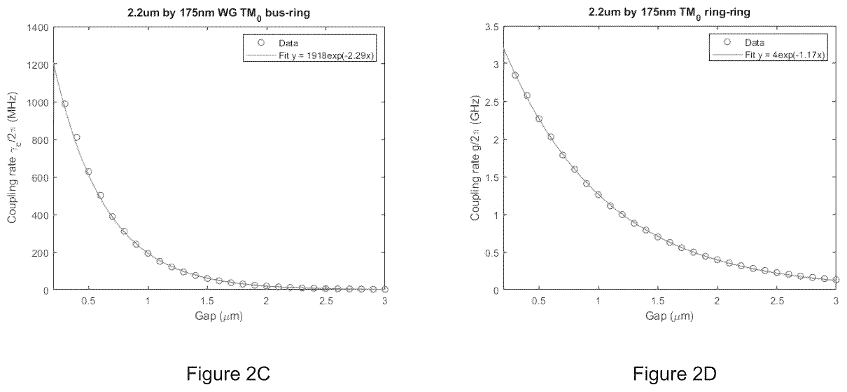

FIG. 2A illustrates the Q measurement of a high contrast filter in accordance with an embodiment of the invention. The ring resonator can have a radius of about 580μm, a width of about 2.2 μm, and a ring-bus gap of about 1.5 μm. The full-width-at-half-maximum (FWHM) of the modulator resonance is measured to be about 43.24 MHz at 1550 nm using a radio frequency (RF) calibrated unbalanced MZI with 5.87 MHz free-spectral-range (FSR) as a frequency ruler. The measurement yields about 7.2 million intrinsic Q, about 3.6 million loaded Q, a corresponding 3.9 dB/m waveguide loss, ring-bus coupling coefficient

$${κ}_{r b}^{2} = \frac{{γ}_{c} {n}_{g} L}{c}$$

of about 0.004, ring-ring coupling rate g about 2.3 GHz (g=Kᵣᵣc/n_{g}L, Kᵣᵣ=gn_{g}L/c=0.29, so Kᵣᵣ²=0.085 (g is extracted from the 3-ring structure)).

FIG. 2B illustrates the frequency response (S11) of a high contrast filter in accordance with an embodiment of the invention.

FIGS. 2C and 2D illustrate coupling rate of a high contrast filter in accordance with an embodiment.

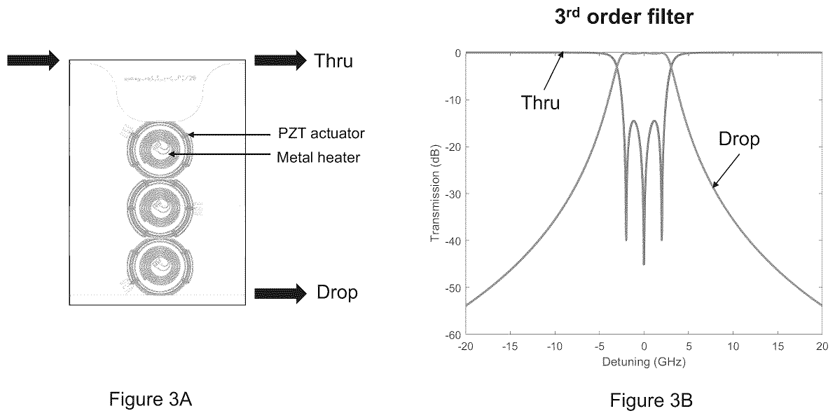

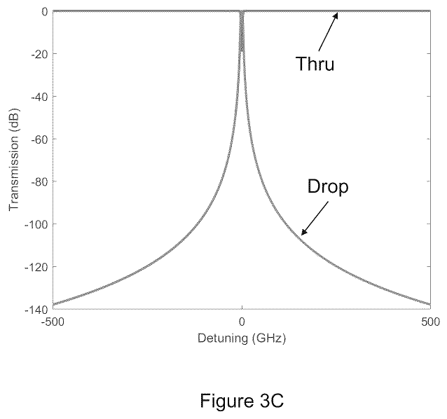

FIG. 3A illustrates a schematic of a high contrast filter with serially coupled 3 ring resonators in accordance with an embodiment of the invention. PZT actuators such as PZT modulators can be used in the filter. Metal heaters including (but not limited to) any thermal conductive metals can be implemented for aligning the 3 rings' spectrum. Examples of the metal heaters include (but are not limited to) platinum. For the 3^{rd} order filter, the ring-bus gap can be about 0.6 μm and 1 μm.

FIGS. 3B and 3C illustrate the performance of the 3^{rd} order filter in accordance with an embodiment of the invention. The Thru curve shows the transmission of the through port and the Drop curve shows the transmission of the drop port. The filter includes 3 ring resonators, and is designed for flat passband. The PZT actuators can achieve fast switch. The bandwidth of the filter is about 6 GHz. The extinction ratio of the filter is greater than about 100 dB. The ring-ring coupling is about 2 GHZ, and the ring-bus coupling is about 4 GHz.

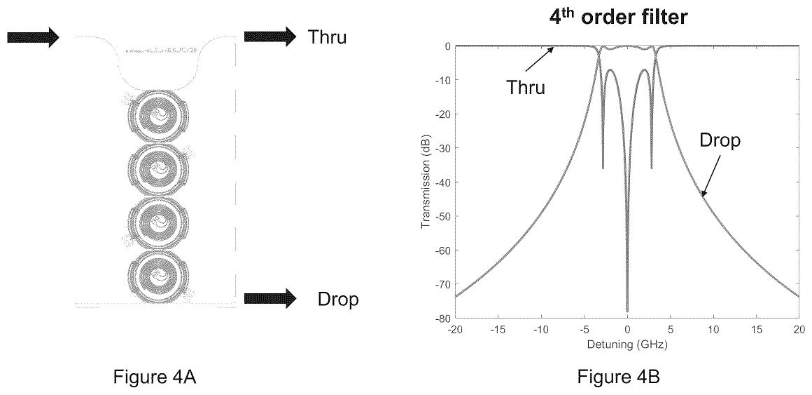

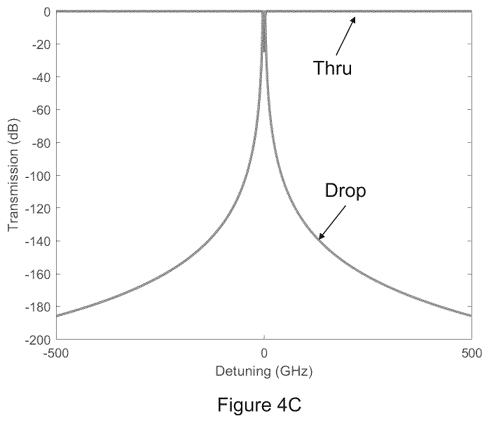

FIG. 4A illustrates a schematic of a high contrast filter with serially coupled 4 ring resonators in accordance with an embodiment of the invention. The filter includes 4 ring resonators. PZT modulators can be included and Pt can be used as the metal heater. As can be readily appreciated, any of a variety of a metal heater can be utilized appropriate to the requirements of specific applications in accordance with various embodiments of the invention. For the 4^{th} order filter, the ring-bus gap can be about 0.6 μm and 1 μm.

FIGS. 4B and 4C illustrate the performance of the 4^{th} order filter in accordance with an embodiment of the invention. The Thru curve shows the transmission of the through port and the Drop curve shows the transmission of the drop port. The filter includes 4 ring resonators, and is designed for flat passband. The PZT actuators can achieve fast switch. The bandwidth of the filter is about 6 GHz. The extinction ratio of the filter is greater than about 120 dB. The ring-ring coupling is about 2 GHZ, and the ring-bus coupling is about 4 GHz. A higher number of coupled ring resonators can result in a higher extinction ratio.

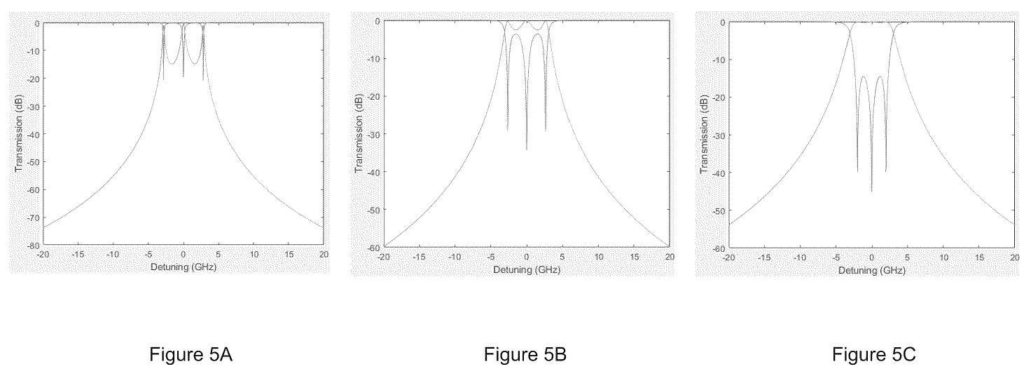

In some embodiments, over-coupling may be needed and can be achieved via a variety of ways such as (but not limited to) increasing the coupling length. FIGS. 5A through 5C illustrate high-order ring filter simulation in accordance with an embodiment. FIG. 5A shows that when ring-ring coupling is about 2 GHZ, the ring-bus gap is about 0.6 μm, and when ring-bus coupling is about 0.5 GHZ, the ring-bus gap is about 0.6 μm. FIG. 5B shows when ring-ring coupling is about 2 GHZ, the ring-bus gap is about 0.6 μm, and the ring-bus coupling is about 2 GHZ. FIG. 5C shows when ring-ring coupling is about 2 GHz, the ring-bus gap is about 0.6 μm, and the ring-bus coupling is about 4 GHz.

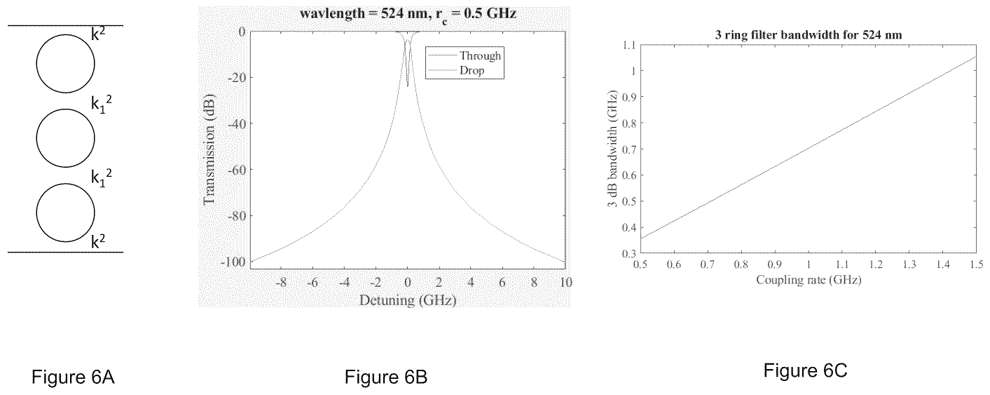

FIGS. 6A through 6C illustrate a high contrast filter for visible wavelength in accordance with an embodiment. FIG. 6A shows a three-ring configuration for a high contrast filter for visible wavelength. For flat response k₁² equals to 0.28k². Ring bus can be a pulley coupler with a length of about 120 μm. Ring-ring can be a point coupler. Actuators can be calibration (DC) and switched (AC). FIG. 6B shows the performance of the 3^{rd} order filter at a visible wavelength of about 524 nm. FIG. 6C shows the three-ring filter bandwidth at about 524 nm wavelength. Table 1 lists the device parameters at different filter bandwidth.

TABLE 1

| Targeted 3 dB bandwidth | | Ring Bus coupling | Ring ring coupling | |
|---|---|---|---|---|
| 0.25 | GHz | 0.28 GHz (1.2 μm gap) | 0.7 | μm gap |
| 0.35 | GHz | 0.5 GHz (1.1 μm gap) | 0.65 | μm gap |
| 0.66 | GHz | 0.75 GHz (1.05 μm gap) | 0.6 | μm gap |
| 0.88 | GHz | 1 GHz (1 μm gap) | 0.55 | μm gap |
| 1 | GHz | 1.5 GHz (0.95 μm gap) | 0.5 | μm gap |

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A high contrast optical filter comprising:
a first ring resonator coupled with a first waveguide; and
a second ring resonator coupled with a second waveguide, wherein the first waveguide directs a light in and the second waveguide directs the light out;
wherein each of the ring resonator is integrated with an actuator; and
wherein the optical filter switches at a bandwidth greater than 1 kHz with a switch time less than 100 ns.

2. The optical filter of claim 1, further comprises at least one more ring resonator, wherein the at least one more ring resonator is coupled in between the first and the second ring resonators, wherein each of the at least one more ring resonator is coupled with an actuator.

3. The optical filter of claim 2, wherein the first ring resonator, the second ring resonator, and the at least one more ring resonator are arranged in a pattern selected from the group consisting of: a coupled linear array, a coupled parallel array, and a 2D array.

4. The optical filter of claim 1, wherein the actuator is a stress-optical actuator, an electro-optical actuator, or a thermo-optical actuator.

5. The optical filter of claim 1, further comprising a heater, wherein the actuator is a thermo-optic actuator.

6. The optical filter of claim 5, wherein the heater comprises a thermally conductive metal.

7. The optical filter of claim 1, wherein the optical filter is configured to be a portion of a blanking gate.

8. The optical filter of claim 1, wherein the actuator is a ring actuator or a phase actuator.

9. The optical filter of claim 1, wherein the first and the second ring resonators have a circular shape.

10. The optical filter of claim 2, wherein each of the actuator is laterally and vertically offset from a core of each of the ring resonator and from an optical mode profile of the ring resonator such that the actuator does not appreciably affect a waveguide loss or a resonator quality factor (Q).

11. The optical filter of claim 10, wherein the core of each of the ring resonator comprises a material selected from the group consisting of: silicon nitride, tantalum pentoxide, alumina oxide, and aluminum nitride.

12. The optical filter of claim 1, wherein the actuator comprises lead zirconate titanate (PZT) and the ring resonator comprises silicon nitride, and the filter functions at a wavelength selected from the group consisting of: a visible wavelength range from 400 nm to 750 nm, a near IR wavelength range from 700 nm to 2500 nm, and a mid IR wavelength range from 2500 nm to 25,000 nm.

13. The optical filter of claim 1, wherein the actuator comprises PZT and the ring resonator comprises tantalum pentoxide, alumina oxide, or aluminum nitride, and the filter functions at a wavelength range selected from the group consisting of: a far-UV wavelength range from 100 nm to 200 nm, a mid-UV wavelength range from 200 nm to 300 nm, a near UV wavelength range from 300 nm to 400 nm, and a visible, near IR and mid-IR wavelength range from 400 nm to 2350 nm.

14. The optical filter of claim 1, wherein each of the ring resonator is a high quality factor (Q) resonator.

15. The optical filter of claim 14, wherein the high Q resonator has a Q of at least 40 million.

16. The optical filter of claim 1, wherein the optical filter is compatible with CMOS foundry fabrication process.

17. The optical filter of claim 1, wherein the optical filter comprises three ring resonators and three metal heaters; wherein the optical filter operates at 1550 nm wavelength, wherein the optical filter has an extinction ratio of greater than or equal to 100 dB at 6GHz bandwidth.

18. The optical filter of claim 1, wherein the optical filter comprises three ring resonators and three metal heaters; wherein the optical filter operates 493 nm wavelength; wherein the optical filter has an extinction ratio of greater than or equal to 80 dB at 1 GHz bandwidth.
